(19) United States
(12) Patent Application Publication
(10) Pub. No.: US 2017/0289697 A1
(43) Pub. Date: Oct. 5, 2017

(54) Sound Generator

(71) Applicant: AAC Technologies Pte, Ltd., Singapore city (SG)

(72) Inventor: Changliang Wang, Shenzhen (CN)

(21) Appl. No.: 15/628,698

(22) Filed: Jun. 21, 2017

Related U.S. Application Data
(63) Continuation-in-part of application No. 14/930,190, filed on Nov. 2, 2015.

(51) Int. Cl. H04R 9/06; H04R 1/02; H04R 9/04; H04M 1/03; H04R 9/02; B06B 1/04

(52) U.S. Cl. CPC H04R 9/06; H04R 9/025; B06B 1/045; H04R 9/046; H04M 1/035; H04R 1/02; H04R 2499/11

(57) ABSTRACT

A sound generator is disclosed. The sound generator includes a frame including a side wall forming a storage space; a voice coil connected with the frame and accommodated in the storage space, the voice coil including a coil body and a coil lead extending from coil body. The coil lead includes a fixed portion connected to the coil body; an arc portion extending from the fixed portion and a projection of the arc portion along a direction perpendicular to a vibrating direction of the voice coil at least partially located within the voice coil body; and a connecting portion extending from the arc portion and connected with the sidewall.

### CROSS REFERENCE TO RELATED APPLICATION

This application is a continuation-in-part application of U.S. Ser. No. 14/930,190 filed on Nov. 2, 2015.

### FIELD OF THE INVENTION

The present invention relates to a sound generator for converting electrical signals into sound waves, more particularly to a miniature sound generator.

### DESCRIPTION OF RELATED ART

In the mobile Internet era, the number of smart mobile devices is on the rise. Among many mobile devices, mobile phone is undoubtedly the most common and most portable mobile terminal device. Currently, mobile phone's functions are much diversified; one of them is high-quality music feature. The speaker of the mobile phone is prerequisite to realize the high quality music feature. The mobile phones on the market at present adopt generally the miniature electromagnetic speaker for music playing.

The sound generator includes normally a frame serving as a housing, a magnetic system fixed in the frame, and a vibration system which interacts with the magnetic system for producing vibrations. The magnetic system typically includes a yoke, a magnet fixed at a center of the yoke, and a magnetic gap formed between the yoke and the magnet. The vibration system typically includes a voice coil extending into the magnetic gap, and a vibrating diaphragm connected to the voice coil.

When the voice coil receives electrical audio signal, the voice coil interacts with a magnetic field of the magnetic system, further generates Ampere Force. Driven by the Ampere Force, the voice coil realizes to-and-fro vibration, thus resulting in the vibration of the vibrating diaphragm, and producing acoustic radiation.

In order to pass a current through the voice coil, the voice coil usually has two wires for connecting electrically to an external signal source. The wires of the speaker extend from a voice coil body. The wires are straight and fixed to a side of the frame. This side position is provided generally with soldering-pan and the fixing mode is generally welding or gluing.

In the vibration process of the voice coil, the wire is also stretched simultaneously. Because the wire is straight and bonded on the side of the frame, the wire bears high plastic strain and the wire is easy to break. In addition, because the wire is straight and bonded on the side of the frame, two parts are substantially parallel, so it would be comparatively difficult to fix properly the wire at the correct position. The actual fixed location and design position may be different.

Therefore, it is necessary to provide an improved sound generator to solve the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a sound generator in accordance with an exemplary embodiment of the present disclosure, in which a frame is assembled with a voice coil.

FIG. 2 is a top view of the sound generator in FIG. 1.

FIG. 3 is an isometric view of the voice coil of the sound generator of the embodiment of the present disclosure.

FIG. 4 is a side view of the sound generator in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

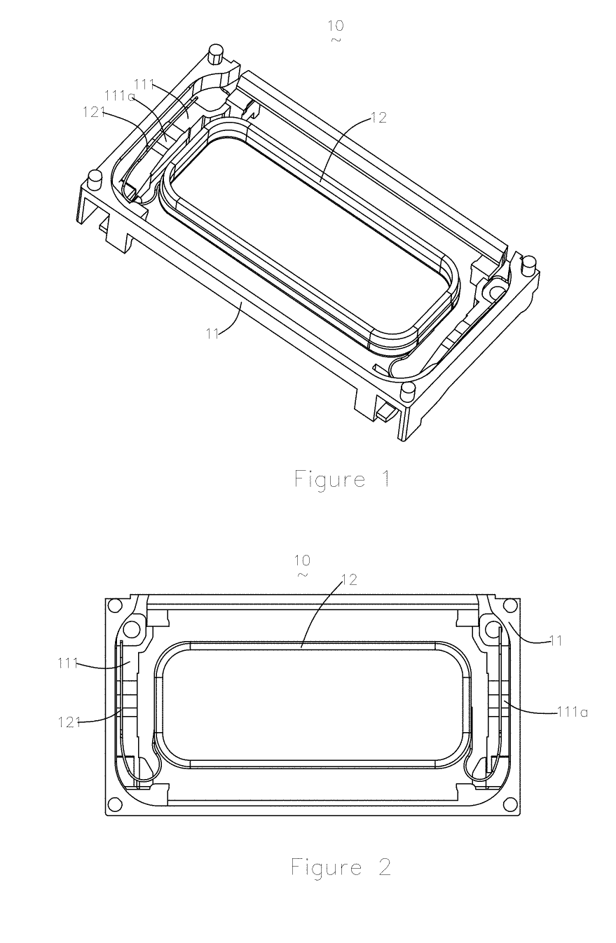

As shown in FIGS. 1 and 2, the sound generator 10 includes a frame 11 and a voice coil 12 connected with the frame 11. The frame 11 is a component for fixing the parts of the sound generator and is made of typically plastic. It may be a part made of the mixture of plastic and other material, such as the injection molding part composed of plastic and metallic material or other kind of assembly. The voice coil 12 is made of metal wire coils and is one of the important components of the sound generator. When an alternating audio current passes through the voice coil, the voice coil generates an audio variation alternating current, which cuts magnetic field lines to generate mechanical vibration, which drives a vibrating diaphragm connected with the voice coil to vibrate and make sound.

It should be noted that only the frame and voice coil are not sufficient to achieve the function of the sound generator to convert the audio electrical signals into sound wave. Magnetic system and the diaphragm connected with the voice coil are also needed. However, this disclosure focuses on the structure and the connection method of the voice coil and the frame, therefore, the general technical personnel can use existing technology and other essential elements rationally to achieve the function of the sound generator.

The frame 11 includes a side wall 111 enclosed as storage space. The voice coil 12 is placed in the storage space. The voice coil 12 includes a coil body 120 and coil leads 121 extending from the voice coil body 120. The voice coil body 120 is suspended in the storage space. In order to achieve the voice coil 12 to be connected electrically with an external audio signal, the terminal of the voice coil lead 121 is fixedly connected with a conductive terminal (not shown in the figure) fitted in the frame 11.

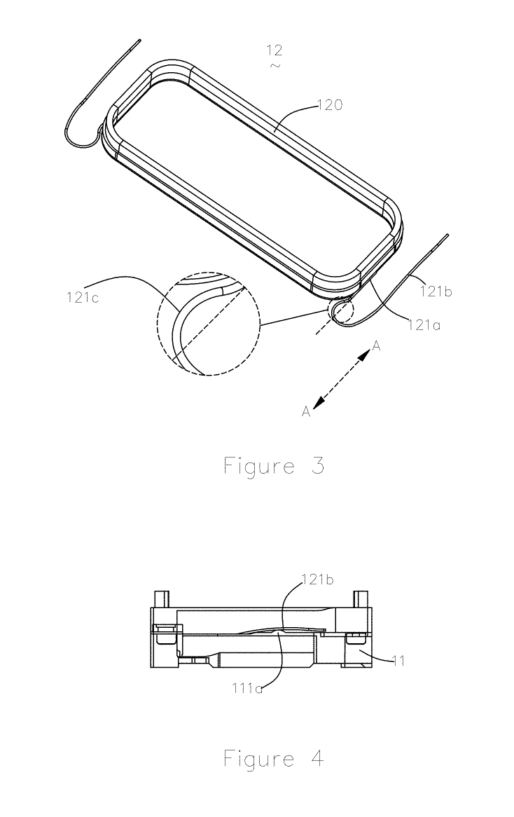

Please also refer to FIG. 3. As shown in figures, the voice coil leads 121 includes a fixed portion 121a which is connected to the voice coil body 120, an arc portion 121c extending from the fixed portion 121a and convex toward the voice coil body 120, and a connecting portion 121b extending from the arc portion 121c toward the side wall 111 of the frame 11 and connected with the sidewall 111. The AA line in FIG. 3 is defined as a direction perpendicular to a vibrating direction of the voice coil 12. A projection of the arc portion 121c along the AA line is at least partially located within the voice coil body 120. The connecting portion 121b and the fixed portion 121a can be located simultaneously on one side of the arc portion 121c, also they can be located in the opposite side of the arc portion 121c according to the actual needs.

Please refer to FIG. 4 and FIG. 1 together. The side wall 111 includes a protruding bump 111a extending outwardly from an upper surface thereof along the vibrating direction of the voice coil. The connecting portion 121b is arc-shaped and the highest point of the arc is bonded by wire sealing glue to the bump 111a. Accordingly, the bump 111a can be used for glue positioning and supporting the voice coil lead wire 121, avoiding the collision between the voice coil lead 121 and the sidewall 111 of the frame 11.

In this embodiment, the bump 111a on the side wall 111 of the frame 11 is positioned under the connecting portion 121b of the voice coil 12, and the connecting portion 121b and the side wall are bonded by bonding technology. In order to connect well the connecting portion 121b of the voice coil lead wire 121 with the bump 111a, the connecting portion 121b is arc shaped in a direction away from the side wall 111 of the frame. The arc shape of the connecting portion 121b may occur naturally in the process of connecting to the bump 111a. The straight lead wire is bent under force when it is pressed on the bump. It may also be arc shaped in advance and then connected to the bump. In alternative mode, after the connecting portion 121b is mounted on the bump 111a, the radius of the arc is greater than the arc radial of the arc portion 121c.

In the present disclosure, the plastic strain on the coil lead of the voice coil is smaller during the vibration of the voice coil, so the coil lead is not easy to break. Furthermore, since connecting portion of the voice coil is connected to the bump on the sidewall of the frame, the connecting point between the connecting portion and the bump is the highest point of the arc connecting portion. It is relatively easier to install and position two parts. In addition, the arc portion is bias toward the voice coil body, so the wire curving process is more easily achieved.

In comparison to the related technology, the general amplitude (0.8 mm) of the voice coil and the signal frequency (850 Hz) are used for testing. The maximum equivalent plastic strain of the voice coil lead wire of the related technology is about 0.0106, and the maximum equivalent plastic strain of the voice coil lead wire of this disclosure is about 0.0038, only 36% of the related technology, improved significantly.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sound generator, including:
a frame including a side wall forming a storage space;
a voice coil connected with the frame and accommodated in the storage space, the voice coil including a coil body and a coil lead extending from coil body, the coil lead including:
a fixed portion connected to the coil body;
an arc portion extending from the fixed portion and a projection of the arc portion along a direction perpendicular to a vibrating direction of the voice coil at least partially located within the voice coil body; and
a connecting portion extending from the arc portion and connected with the sidewall.

2. The sound generator according to claim 1, wherein the side wall includes a protruding bump extending from an upper surface thereof along a vibration direction of the voice coil, and the connecting portion of the coil lead is bonded to the protruding bump.

3. The sound generator according to claim 2, wherein the connecting portion is bonded to the protruding bump by wire sealing glue.

4. The sound generator according to claim 2, wherein the connecting portion is arc-shaped and the highest point of the arc is connected to the protruding bump.

5. The sound generator according to claim 1, wherein the fixed portion is connected to a minor axis side of the coil body.
